(19) United States
(12) Patent Application Publication
(10) Pub. No.: US 2006/0032150 A1
(43) Pub. Date: Feb. 16, 2006

(54) Method for producing improved cerium oxide abrasive particles and compositions including such particles

(76) Inventors: Jae Hyun So, Seoul-city (KR); Dong Jun Lee, Seoul-city (KR); Kyoung Moon Kang, Gwangmyeong-sity (KR); Nam Soo Kim, Suwon-sity (KR); Sung Taek Moon, Suwon-city (KR); Bong Su Ahn, Seoul-city (KR)

Correspondence Address: HARNESS, DICKEY & PIERCE, P.L.C., P.O. BOX 8910, RESTON, VA, 20195, US

(21) Appl. No.: 11/048,907

(22) Filed: Feb. 3, 2005

(30) Foreign Application Priority Data
Aug. 16, 2004 (KR) 2004-64226

(51) Int. Cl. C01F 17/00; B24D 3/02

(52) U.S. Cl. 51/309; 423/263

(57) ABSTRACT

Provided are methods for manufacturing improved cerium oxide abrasives suitable for forming slurry compositions suitable for CMP processes. The cerium oxide abrasives are produced by the heat treatment of a mixture of a cerium precursor compound and an impurity metal compound under conditions that produce primary cerium oxide particles that are incorporated in larger secondary abrasive particles. The presence of the impurity metal and/or the incompletely oxidized cerium within the secondary abrasive particle tend to reduce its mechanical strength, thereby reducing the likelihood of damaging a substrate surface during a CMP process utilizing such abrasives.

### PRIORITY STATEMENT

This application claims priority under 35 U.S.C. § 119 to Korean Patent Application No. 2004-64226, which was filed on Aug. 16, 2004, the contents of which is incorporated herein, in its entirety and for all purposes, by reference.

### BACKGROUND OF THE INVENTION

1. Field of the Invention

The invention provides a method for producing improved abrasive particles, a method for producing a slurry including such abrasive particles suitable for use in a CMP (Chemical Mechanical Polishing) process, a method of polishing a semiconductor wafer using such a slurry, and a method of manufacturing a semiconductor device incorporating one or more CMP processes employing the improved abrasive particles.

2. Description of the Related Art

Chemical mechanical polishing (CMP) processes encompass a variety of planarization techniques widely used in most current silicon integrated circuit (IC) fabrication processes for satisfying the local and global planarity constraints imposed by current photolithography methods. CMP processes are used to planarize dielectrics, both for planarizing the insulators between metal levels (commonly referred to as interlevel oxides (ILO) or interlayer dielectrics (ILD)) and for forming shallow trench isolation (STI) structures and for planarizing metal layers such as tungsten and copper for forming the conductive structures in multilevel metal damascene processes. The need for the productivity and performance offered by the various CMP processes will tend to maintain or increase their utilization in advanced IC manufacture.

Depending on the material being removed the CMP processes may employ a range of slurry compositions and abrasive particles for removing the intended material from the surface of a semiconductor wafer. The abrasive particles are frequently selected from metal oxides such as alumina (Al₂O₃), silica (SiO₂), ceria (CeO₂), zirconia (ZrO₂), and titania (TiO₂), and may include particles having a range of particle sizes. The slurry composition will also include a number of additives, such as surfactants, buffers, complexing agents, viscosity adjusters, acids and/or bases for controlling the pH, to provide a slurry composition that is adapted for a particular application.

The most stable oxide of cerium is cerium dioxide, CeO₂, which is also commonly referred to as ceria or, somewhat less frequently, as ceric oxide. When cerium salts are calcined in air or other oxygen-containing environments, this tetravalent Ce(IV) oxide is formed. Cerium (along with the other lanthanides) has one of the highest free energies of formation for an oxide and the resulting cerium oxide, while soluble in mineral acids, can prove difficult to dissolve in the absence of a reducing agent such as hydrogen peroxide. Ceria has a fluorite, CaF₂, crystal structure with eight coordinate cations and four coordinate anions and can, therefore, generally be visualized as a cubic close-packed array of metal atoms with oxygen atoms filling all the tetrahedral holes.

Slurry additives can include, for example, quaternary ammonium compounds having a general formula N(R₁R₂R₃R₄)}⁺X⁻, in which R₁, R₂, R₃, and R₄ are radicals, and X⁻ is an anion derivative including halogen elements. The quaternary ammonium compound may be one of [(CH₃)₃NCH₂CH₂OH]Cl, [(CH₃)₃NCH₂CH₂OH]F, [(CH₃)₃NCH₂CH₂OH]Br, [(CH₃)₃NCH₂CH₂OH]CO₃, and mixtures thereof. Various pH control agents may also be incorporated as bases, for example, KOH, NH₄OH, [(CH₃)₃NCH₂CH₂OH]OH and/or (CH₃)₄NOH, and acids, for example HCl, H₂SO₄, H₃PO₄ and/or HNO₃. The slurry may further include a surfactant such as cetyldimethyl ammonium bromide, cetyldimethyl ammonium bromide, polyethylene oxide, polyethylene alcohol or polyethylene glycol.

### SUMMARY OF THE INVENTION

Provided is a method of preparing cerium oxide particles, comprising: heating a mixture of a cerium precursor compound and a minor amount of an impurity metal compound or metal oxide precursor to a heat treatment temperature of between about 700° C. and about 900° C. under an oxidizing ambient; maintaining the cerium precursor compound at the heat treatment temperature for a treatment period sufficient to obtain a treated cerium compound in which substantially all of the cerium precursor compound has been converted to cerium oxide (CeO₂); separating the cerium oxide according to particle size; and forming an aqueous dispersion of cerium oxide particles within a predetermined particle size range. During the preparation of the cerium oxide particles the oxidizing ambient may be a gas mixture including at least about 20 volume percent oxygen and may be maintained at a pressure of at least about 1 atmosphere.

The cerium precursor compound may be selected from a range of cerium compounds including acetates, carbides, carbonates, chlorides, cyanates, bromides, fluorides, oxalates, sulfates, sulfites, and thiosulfates that have a melting point under the oxidation conditions of at least about 715° C. and as high as about 915° C. or more. Representative cerium precursor compounds include, for example, Ce₂(CO₃)₃, Ce(OH)₄, CeC₂, Ce(O₂C₂H₃)₃, CeBr₃, CeCl₃, CeF₃, CeF₄, Ce₂(C₂₀ ₄)₃, Ce(SO₄)₂, Ce₂(SO₄)₃ and mixtures thereof in both hydrated and anhydrous forms. If the cerium precursor is being used in its hydrated form, a dehydration step may be incorporated before heating the cerium precursor to the heat treatment temperature. Representative impurity metal compounds include, for example, Al₂O₃, SiO₂, TiO₂, ZrO₂, MnO₂ and mixtures thereof.

Once the cerium oxide particles have been produced, they may be separated by size using one or more well known techniques including, for example, centrifugation, sedimentation and filtration and may incorporate mechanical disruption processes for reducing the average size of the cerium oxide particles before or in conjunction with the separation technique.

Also provided is a technique for preparing cerium oxide particles, comprising: heating a mixture of a cerium precursor compound and a minor amount of an impurity metal compound or metal oxide precursor to a heat treatment temperature of between about 700° C. and about 900° C. under an oxidizing ambient; maintaining the cerium precursor compound at the heat treatment temperature for a treatment period sufficient to obtain a treated cerium compound in which the oxidation of the cerium is not complete and the cerium precursor compound has been converted to a cerium oxide compound that may be represented by the formula CeOₓ, wherein 0<x<2; separating the cerium oxide compound according to particle size; and forming an aqueous dispersion of cerium oxide compound particles within a predetermined particle size range.

During preparation of the cerium oxide compound, the oxidizing ambient utilized may be a gas mixture that includes no more than about 20 volume percent oxygen such as, for example, air diluted with one or more inert gases, and/or is maintained at a pressure of no more than about 1 atmosphere. The inert gases may include, for example, nitrogen (N₂), argon (Ar), or helium (He).

The cerium precursor compound may be selected from a range of cerium compounds including acetates, carbides, carbonates, chlorides, cyanates, bromides, fluorides, oxalates, sulfates, sulfites, and thiosulfates that have a melting point under the oxidation conditions of at least about 715° C. and possibly about 915° C. or more. Representative cerium precursor compounds include, for example, Ce₂(CO₃)₃, Ce(OH)₄, CeC₂, Ce(O₂C₂H₃)₃, CeBr₃, CeCl₃, CeF₃, CeF₄, Ce₂(C₂O₄)₃, Ce(SO₄)₂, and Ce₂(SO₄)₃ in both hydrated and anhydrous forms. If the cerium precursor is being used in its hydrated form, a dehydration step may be incorporated before heating the cerium precursor to the heat treatment temperature. Representative impurity metal oxide compounds include, for example, Al₂O₃, SiO₂, TiO₂, ZrO₂, MnO₂ and mixtures thereof.

Depending on the heat treatment conditions and the duration of the heat treatment, the cerium precursor may be incompletely oxidized to produce a cerium oxide compound CeOₓ that satisfies the expression 1≦x<2. Similarly, the heat treatment conditions may be modified to produce a cerium oxide compound CeOₓ that satisfies the expression 1≦x≦1.9.

Also provided is a technique for utilizing the cerium oxide particles prepared in accord with the methods of the invention in formulating slurry compositions by combining one or more types of the cerium oxide and/or cerium oxide compound abrasive particles, usually provided as a suspension or a dispersion, with an aqueous additive solution in a predetermined proportion. The aqueous additive solution will typically include at least one polymeric acid or a salt thereof, such as polyacrylic acid, polyacrylic-maleic acid and polymethyl vinyl ether-alt maleic acid. When more than one polymeric acid or their salts are utilized, the polymeric acids will tend to have different mean molecular weights and may be independently selected from polymeric acids such as the previously noted polyacrylic acid, polyacrylic-maleic acid and polymethyl vinyl ether-alt maleic acid. The additive solution can also include a base, such as sodium hydroxide, potassium hydroxide, ammonium hydroxide and basic amines to adjust the pH of the resulting slurry to a more neutral pH range, e.g., a pH of about 6-8.

Also provided is a technique for planarizing a substrate using such a slurry and the cerium oxide abrasive particles of the invention comprising: placing the substrate on a carrier; urging a primary surface of the substrate against a pad surface while generating relative motion between the substrate and the pad; and applying a slurry composition to the pad so that a portion of the slurry composition is between the primary surface and the pad surface, the slurry composition cooperating with the pad surface to remove an upper portion of the substrate; wherein the slurry composition includes cerium oxide particles, substantially all of which are within a predetermined size range, the cerium oxide particles having been manufactured by heating a cerium precursor compound to a heat treatment temperature of between about 700° C. and about 900° C. under an oxidizing ambient; maintaining the cerium precursor compound at the heat treatment temperature for a treatment period sufficient to obtain a treated cerium compound in which substantially all of the cerium precursor compound has been substantially completely converted to cerium oxide (CeO₂) or an incompletely oxidized cerium oxide compound (CeOₓ) wherein x satisfies the expression 0<x<2, or, in some instances, the expression 1≦x≦1.9; separating the cerium oxide according to particle size; forming an aqueous dispersion of cerium oxide particles within a predetermined particle size range; and combining the aqueous dispersion of cerium oxide particles with a second aqueous additive solution in a predetermined proportion to form a slurry composition.

### BRIEF DESCRIPTION OF THE DRAWINGS

The invention will become more apparent by describing in detail exemplary embodiments thereof with reference to the attached drawings in which:

FIGS. 1A and 1B illustrate exemplary silica and ceria abrasive particles;

FIGS. 2A and 2B illustrate polishing defects resulting from the use of silica and ceria abrasive particles, respectively;

FIG. 3A represents a composite ceria abrasive particle prepared according to the invention incorporating an impurity metal oxide;

FIG. 3B represents a cerium oxide (CeOₓ) abrasive particle having radially varying stoichiometry;

FIGS. 4A-4C illustrate the effect of identical scratches across semiconductor devices of varying size;

FIGS. 5-8 are flowcharts relating to exemplary methods according to the invention; and

FIGS. 9-11 are graphs illustrating the results of various evaluations detailed in the specification.

These drawings have been provided to assist in the understanding of the exemplary embodiments of the invention as described in more detail below and should not be construed as unduly limiting the invention. In particular, the relative spacing, positioning, sizing and dimensions of the various elements illustrated in the drawings are not drawn to scale and may have been exaggerated, reduced or otherwise modified for the purpose of improved clarity.

Those of ordinary skill in the art will also appreciate that a range of alternative configurations have been omitted simply to improve the clarity and reduce the number of drawings. Those of ordinary skill will also appreciate that certain of the various process steps illustrated or described with respect to the exemplary embodiments may be selectively and independently combined to create other methods useful for manufacturing semiconductor devices without departing from the scope and spirit of this disclosure.

### DETAILED DESCRIPTION OF EXEMPLARY EMBODIMENTS

Efforts to reduce semiconductor device dimensions and/or increase device density, combined with the development of new interconnect technologies (such as copper and reduced capacitance (also referred to as low K or low ε) polymer based dielectrics) has led to the introduction and rapid development of chemical-mechanical planarization (CMP) technology in semiconductor manufacturing. CMP processes include a wide range of global planarization processes suitable for use in the manufacture of multilevel circuits having feature sizes of 0.5 μm and below. As the device feature size decreases, the RC interconnect delay (a function of the resistance (R) and capacitance (C) of the circuit) tends to increases non-linearly and dominate gate delay (a function of the transistor switching) as a limitation to device operating speed. To address the increases in RC interconnect delay, various multilevel metallization (MLM) techniques, in which a series of conductive patterns are separated by dielectric insulating layers, have been developed to improve the scaling factor for interconnection patterns.

In MLM processes, the different metal interconnection patterns are formed on several different planes that are generally isolated from one another by insulating layers, sometimes referred to as interlevel dielectrics (ILD) and selectively interconnected through conductive structures, such as conductive plugs, formed through via holes etched through the ILD. Most of the difficulties associated with MLM structures relate to the associated deposition processes, the alignment and process precision with which the photolithography, patterning and etching processes can be conducted, and the degree of planarization that can be achieved between interconnection patterns. CMP processes provide alternatives to other conventional planarization processes such as reflow, spin-on-glass (SOG), bias sputtering, dry etching, and etch back processes. Appropriate CMP processes will tend to provide improved versatility, simplicity and better global planarization for a wide range of materials than can be achieved with the conventional planarization processes.

In addition to addressing the need for global planarization, CMP processes have proven useful in forming patterns from materials such as copper, which is difficult to etch and pattern using conventional dry etching methods. The “damascene” or “inlaid approach” deposits a blanket copper layer on a substrate layer, such as silica, that has previously been patterned and etched to form trenches corresponding to the desired metal pattern. The conductive copper pattern remains within the trenches after a CMP process is applied to remove the upper portion of the copper layer.

CMP processes provide for the synergistic combination of both tribological and chemical effects to planarize both conductive and insulating materials such as copper, tungsten, silica and polymers. In addition to global planarization and relatively high removal or polishing rates, CMP processes can also be adapted to provide some degree of material selectivity (a higher polishing rate of one material compared to another material under the same process conditions), and a high quality surface that is largely free of defects such as scratches, pits and particulate contamination. The CMP process materials, abrasives, additives, etc., can be customized to improve the process performance with respect to the primary material, and sometimes secondary materials, that will be removed from the wafer surface. Typical CMP slurries contain small (<300 nm) abrasive particles at concentrations ranging from about 1 to 10 wt % and several additives (surfactants, stabilizers, complexing agents, etc.) to improve the material removal rate and/or the selectivity of the slurry and/or stabilize the slurry components.

Another consideration in defining CMP processes is the relative hardness and morphology of the abrasive material(s) and the material(s) being removed from the semiconductor wafer surface. For example, low resistivity metals, such as copper and silver, and low K materials desirable for higher performance interconnection patterns are typically much softer than the conventional interconnection materials such as tungsten and polysilicon. For example, the micro-hardness of copper is about 80 kg/mm² (Mohs scale equivalent of about 2.5) compared with abrasive materials such as silica and ceria (about 1200 kg/mm² [Mohs scale 6-7]), and alumina (about 2000 kg/mm² [Mohs scale 9]). The CMP of soft surfaces using such hard abrasive-based slurries tends to increase the likelihood of producing surface scratches and/or pits on the planarized surface.

Another type of defect seen in CMP processes, particularly when planarizing a surface having materials of varying hardness, such as copper and silicon oxide, is “dishing” where a central portion of the exposed width of the softer material is removed more rapidly than edge portions, thereby producing a concave surface or trough. Dishing tends to increase the resistance of the resulting conductive pattern and, as a result of the lack of planarity, can lead to increases in the particulate contamination as well.

The abrasive particles used in more demanding CMP possesses tend to have an average particle size of less than about 300 nm based on the general observation that, all other parameters being equal, smaller abrasive particles tend to leave fewer defects on the polished surface. However, smaller abrasive particles can also associated with lower material removal rates, reducing the process throughput, and tend to be more difficult to remove from the polished surface after completion of the CMP process, increasing the chance of particulate contamination and/or complicating the clean-up processes.

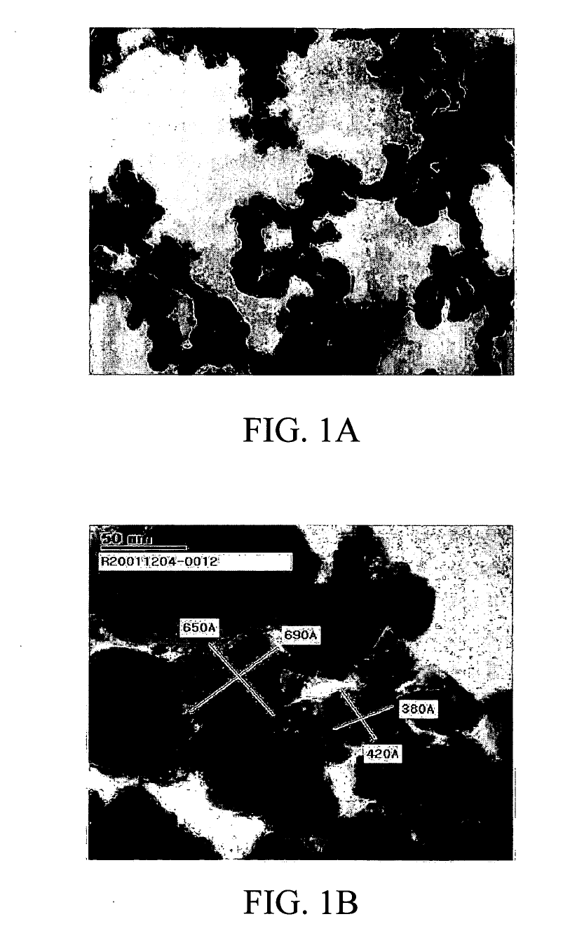

As illustrated in FIGS. 1A and 1B, silica and ceria abrasive particles tend to exhibit variations in morphology. The silica particles. FIG. 1A, tend to be smaller and exhibit a more amorphous structure and a more rounded configuration than the ceria particles illustrated in FIG. 1B. Conversely, the ceria particles, FIG. 1B, tend to be larger and have a higher degree of crystallinity, both parameters that will tend to increase the material removal rate and increase the likelihood of scratches. These tendencies are somewhat offset, however, by the improved silicon oxide/silicon nitride selectivity exhibited by CMP slurries including ceria abrasive particles rather than silica abrasive particles and improved planarization characteristics. Accordingly, CMP slurries incorporating ceria abrasives are becoming more widely used in manufacture process of semiconductor devices, particularly those with demanding design rules of 0.15 μm and below.

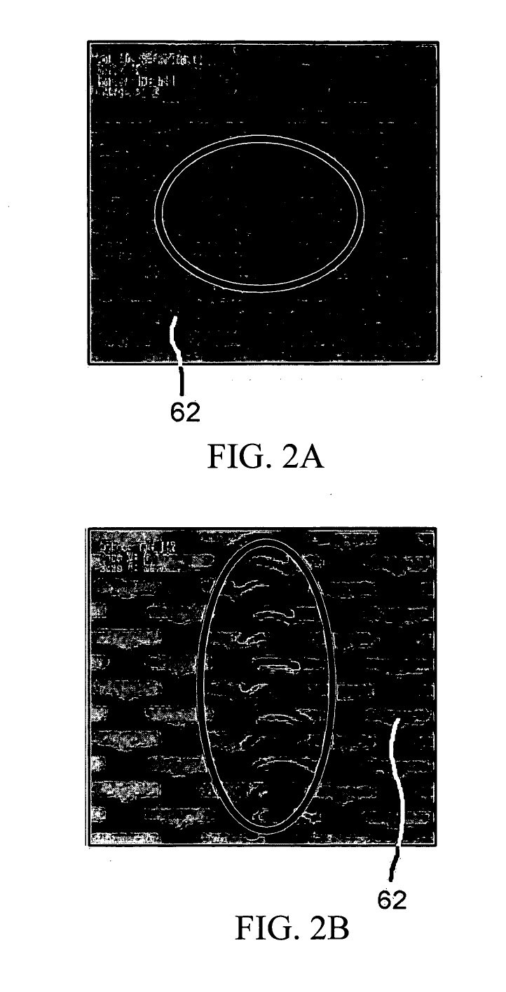

As suggested above, however, and illustrated in FIGS. 2A and 2B, the increased size and crystallinity of the ceria abrasive particles tends to increase the number and severity of CMP-induced defects on the substrate surface. As illustrated in FIG. 2A, the circled region of the semiconductor wafer surface pattern 62 includes a scratch produced during a CMP process utilizing a silica-based CMP slurry. As illustrated in FIG. 2B, however, a scratch in the circled region of the semiconductor wafer surface pattern 62 resulting from the use of a corresponding ceria-based CMP slurry is much more severe. The CMP slurries incorporating ceria abrasive particles, therefore, tend to exhibit a greater yield loss and reduced reliability relative to those prepared with the silica abrasive particles.

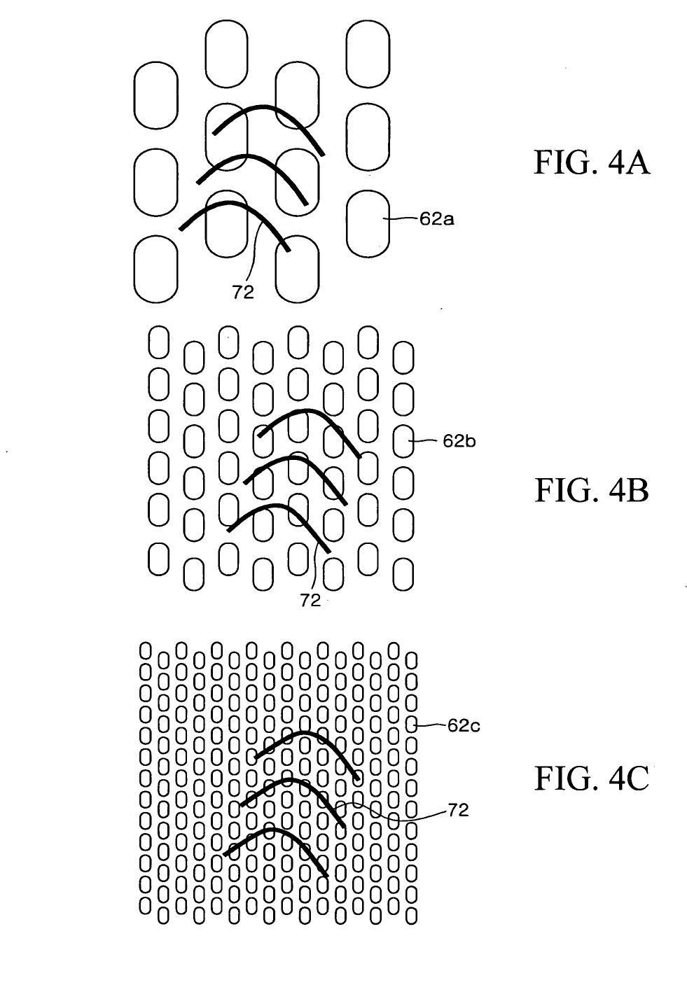

As illustrated in FIGS. 4A-4C, the effect of a polishing defect 72 generated on the surface of a semiconductor wafer during a CMP process will vary according to the relative size and placement of the individual chips 62a, 62b, 62c, that represent devices designed and manufactured according to design rules of decreasing size. Even though the defect size is same, the number of the chips affected in a given area increases.

One method for addressing the increase in polishing defects associated with larger particles is to remove selectively the larger particles, typically using a filter, before applying the slurry to the polishing surface. The nature of the slurry compositions, however, coupled with limitations of conventional filtering technology, tend to complicate the ability to remove the objectionable larger particles while effectively passing all of the appropriately sized particles.

The invention addresses this issue by improving the performance of ceria abrasive particles by altering the particle microstructure through the inclusion of a minor amount of a metal oxide impurity. Ceria particles prepared according to this method, compared with conventional ceria particles, provide increased polishing speed while also tending to reduce the number of polishing defects such as scratches and related problems.

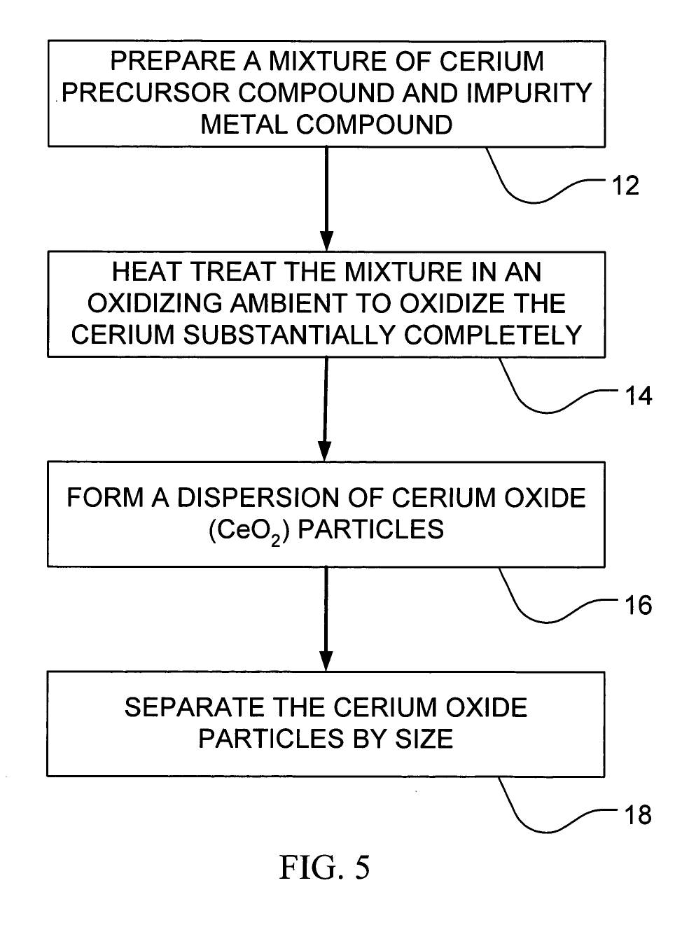

As illustrated in the flowchart provided in FIG. 5, ceria oxide polishing particles may be produced according to the invention by a first exemplary method that includes preparing 12 and heating 14 a mixture of at least one cerium precursor compound and an impurity metal compound, such as a metal oxide, to a heat treatment temperature of between about 700° C. and about 900° C. under an oxidizing atmosphere.

The heat treatment step will be conducted in a furnace or a reactor having a heater capable of obtaining and maintaining the heat treatment temperature. The reactor may also be capable of selectively controlling the composition of the atmosphere within the reactor and/or controlling the pressure of the atmosphere within the reactor during the heat treatment cycle. Depending on the nature of the cerium precursor compounds and the other process parameters, the heat treatment duration may be between about 2.5 and about 5 hours to obtain the desired degree of oxidation within the cerium precursor compound. In this exemplary embodiment, the heat treatment is typically maintained for a time sufficient to oxidize substantially all of the cerium completely to form CeO₂.

The cerium precursor compound(s) should generally be selected to have an individual or combined melting point that is higher than the heat treatment temperature by at least the margin of temperature control provided by the reactor to maintain a solid phase reaction. The cerium precursor compound may include one or more of Ce₂(CO₃)₃, Ce(OH)₄, CeC₂, Ce(O₂C₂H₃)₃.xH₂O, CeBr₃, Ce₂(CO₃)₃.xH₂O, CeCl₃.xH₂O, CeCl₃, CeF₃, CeF₄, Ce₂(C₂₀ ₄)₃, Ce(SO₄)₂ and/or Ce₂(SO₄)₃. The impurity metal compound may include one or more of Al₂O₃, SiO₂, TiO₂, ZrO₂ and/or MnO₂ and may be present in a concentration of between about 300 and about 1000 ppm with respect to the cerium precursor compound.

As illustrated in FIG. 5, after the heat treatment has been completed, the cerium oxide may be dispersed 16 in an aqueous solution to form a dispersion or suspension. The aqueous solution may be formed by mixing de-ionized (D.I.) water with a dispersion agent, which may be one or more anionic organic dispersion agents, cationic organic dispersion agents or non-ionic organic dispersion agents. As also illustrated in FIG. 5, the mean diameter size of the cerium oxide particles may be controlled to within a desired particulate size range by filtering or otherwise separating 18 the dispersion by particle size.

If filtering is utilized for separating the particles by size, before conducting the filtering process, the dispersion may be subjected to a centrifugation step for removing larger particles. Once substantially all of the larger particles have been removed, dispersion can be filtered with the filtrate of the sized cerium oxide particle dispersion subsequently being combined with similar or modified aqueous solutions and/or dispersions to prepare a cerium oxide dispersion in which the majority of the cerium oxide particles exhibit a desired particle size range.

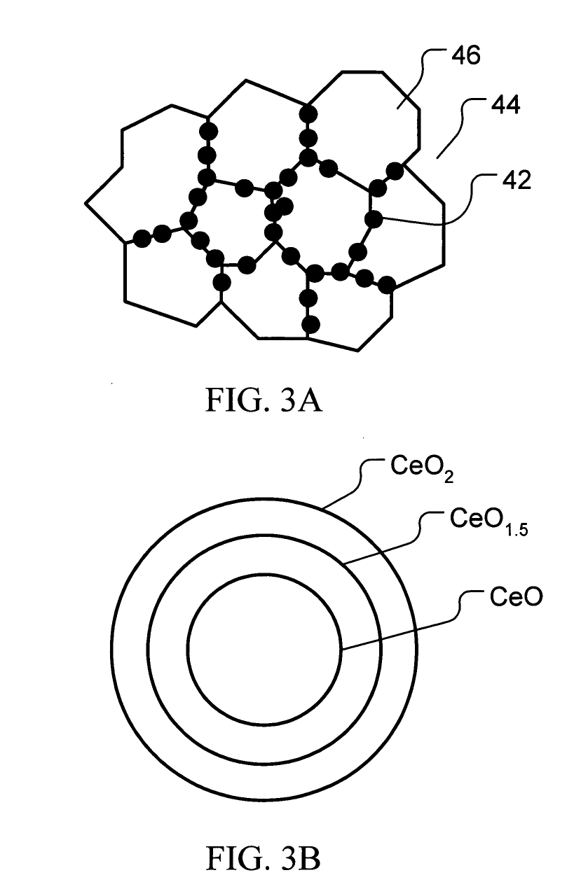

As illustrated in FIG. 3A, the impurity metal compound 42 tends to interact with the cerium oxide during the oxidation process and accumulate as an impurity metal oxide along the grain boundaries formed between adjacent primary cerium oxide particles 46 that combine to form a secondary cerium oxide particle 44. The presence of this low level of metal oxide impurity, typically between about 300 ppm and about 1000 ppm based on the quantity of the cerium precursor, tends to reduce the crystalline strength of the secondary cerium oxide particle. As a result, the secondary cerium oxide will tend to fracture more easily upon contact with a structure on the surface of a semiconductor wafer undergoing a CMP process, thereby reducing the effective size of the abrasive particle and reducing the likelihood of scratching the surface of the semiconductor wafer.

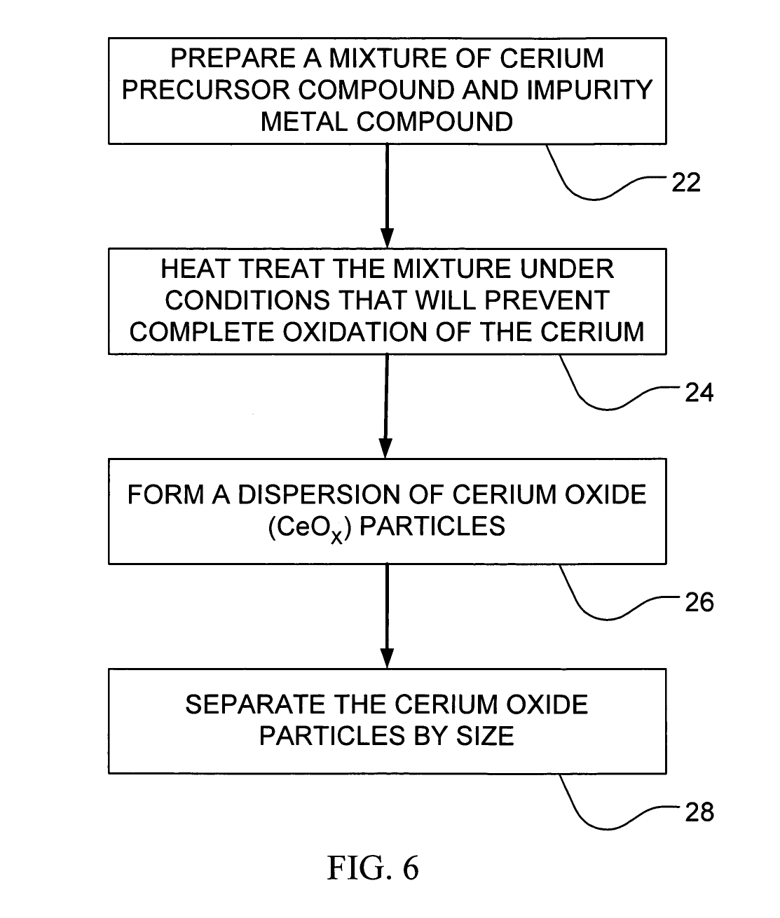

As illustrated in the flowchart provided in FIG. 6, ceria oxide polishing particles according to the invention may be produced by a second exemplary method that includes preparing 22 and heating 24 a mixture of at least one cerium precursor compound and a metal oxide compound impurity to a heat treatment temperature of between about 700° C. and about 900° C. under an oxidizing atmosphere in which the oxygen concentration is reduced, either continuously, step-wise or periodically, to suppress the complete oxidation of the cerium precursor compound(s) within the reactor.

The oxygen concentration may typically be reduced by introducing an inert gas, such as N₂, Ar or He, that will act as a diluent for the O₂ present in the reactor. Similarly, the partial pressure of the O₂ may be reduced by performing the oxidation reaction under a partial vacuum. Another method for reducing the O₂present in the reactor is to introduce a combustible gas, such as H₂, that will tend to consume a portion of the O₂ as it “burns,” but will not tend to introduce any contaminants into the reactor. The technique or techniques for reducing the quantity of oxygen within the reactor may be selected depending on the degree of reduction in the O₂ concentration desired and the configuration of the reactor.

The heat treatment step may be conducted in a furnace or a reactor having a heater capable of obtaining and maintaining the heat treatment temperature, selectively controlling the composition of the atmosphere within the reactor and/or controlling the pressure of the atmosphere within the reactor for the duration of the heat treatment cycle. Depending on the nature of the cerium precursor compounds and the other process parameters, the heat treatment duration may be between about 2.5 and about 5 hours to obtain the desired degree of oxidation within the cerium precursor compound. In this exemplary embodiment, the heat treatment is typically maintained for a time sufficient to oxide the cerium only partially and form CeOₓ, where x satisfies the expression 0<x<2, or, more typically, 1<x≦1.9.

The cerium precursor compound(s) should generally be selected to have an individual or combined melting point that is higher than the heat treatment temperature by at least the margin of temperature control provided by the reactor to maintain a solid phase reaction. The cerium precursor compound may include one or more of Ce₂(CO₃)₃, Ce(OH)₄, CeC₂, Ce(O₂C₂H₃)₃.xH₂O, CeBr₃, Ce₂(CO₃)₃.xH₂O, CeCl₃.xH₂O, CeCl₃, CeF₃, CeF₄, Ce₂(C₂₀ ₄)₃, Ce(SO₄)₂ and/or Ce₂(SO₄)₃. The impurity metal oxide compound may include one or more of Al₂O₃, SiO₂, TiO₂, ZrO₂ and/or MnO₂ and may be present in a concentration of between about 300 and about 1000 ppm with respect to the cerium precursor compound.

As illustrated in FIG. 6, after the heat treatment has been completed, the cerium oxide may be dispersed 26 in an aqueous solution to form a dispersion or suspension. The aqueous solution may be formed by mixing de-ionized (D.I.) water with a dispersion agent, which may be one or more anionic organic dispersion agents, cationic organic dispersion agents or non-ionic organic dispersion agents. As also illustrated in FIG. 6, the mean diameter size of the cerium oxide particles is controlled to within a desired particulate size range by filtering or otherwise separating 28 the dispersion by particle size.

If filtering is utilized for separating the particles by size, before conducting the filtering process, the dispersion may be subjected to a centrifugation step for removing larger particles. Once substantially all of the larger particles have been removed, dispersion can be filtered with the filtrate of the sized cerium oxide particle dispersion subsequently being combined with similar or modified aqueous solutions and/or dispersions to prepare a cerium oxide dispersion in which the majority of the cerium oxide particles exhibit a desired particle size range.

As illustrated in FIG. 3B, in an exemplary embodiment of the method according to FIG. 6, the oxidizing gas will diffuse into the particles of the cerium precursor compound and tend to oxidize the cerium atoms it encounters. However, by controlling the duration of the oxidation process, the concentration of the oxidizing gas and/or the partial pressure of the oxidizing gas, the oxidation process can be interrupted prior to completion. As will be appreciated by those skilled in the art, the CeOₓ cerium oxide compound will include a range of stoichiometries among the various cerium oxide compound particles and/or within a single cerium oxide compound (shown) that produces an average stoichiometry of CeOₓ, even though only a small fraction of the actual cerium oxide compound is likely to correspond to that formula.

In one exemplary embodiment of the method, one or more inert gases may be introduced into the reactor to dilute the air entering the reactor and produce a temperature treatment ambient that is between about 10 and about 20 percent oxygen by volume. The volume of inert gas or gases necessary to achieve this reduction in the oxygen concentration will, of course, depend on the flow rate of gases into the reactor and may be adjusted as necessary to maintain the desired concentration. As noted above, a similar effect may be achieved by reducing the pressure within the reactor to between about 0.5 and 0.95 atmospheres, introducing a combustible fuel at a rate sufficient to consume between about 5 and about 50 percent of the oxygen present, or a combination of methods adjusted to obtain the desired oxygen concentration.

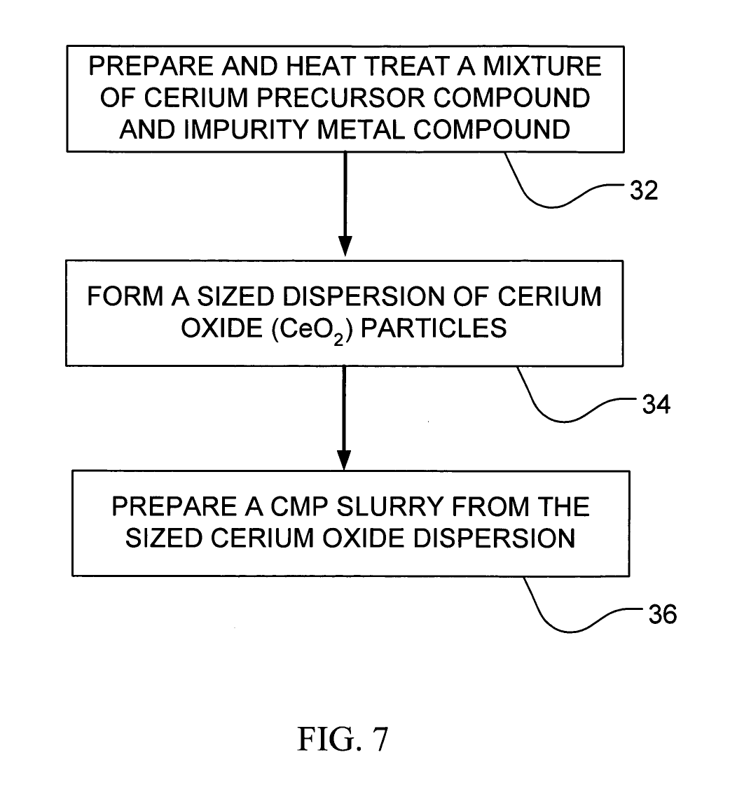

As illustrated in FIG. 7, either of the exemplary methods outlined above for the preparation of cerium oxide particles 32 having a desired particle size range 34 may be utilized to prepare a dispersion including the selected abrasive particles. This dispersion can then be used to produce an exemplary CMP slurry composition 36 according to the invention that comprises cerium oxide abrasive particles produced by one or both of the exemplary methods described above. The slurry composition will also typically comprise at least one of the dispersion agent and a surface active agent.

The use of one or more additives in the slurry composition will tend to improve its stability, polishing rate and/or its selectivity with respect to at least two of the materials that are expected to be present on the semiconductor substrate to which the slurry composition will be applied. The range of additive agents may include a first polymeric acid having a first mean molecular weight, a salt of the first polymeric acid being prepared by a reaction with a first basic material, the second polymeric acid having a second mean molecular weight, a salt of the second polymeric acid being prepared by a reaction with a second basic material, the second mean molecular weight being larger than the first mean molecular weight. The first polymeric acid may be selected from polyacrylic acid, polyacrylic acid-co-maleic acid or polymethylvinylether-alt-maleic acid. Similarly, the second polymeric acid may be selected from polyacrylic acid, polyacrylic acid-co-maleic acid or polymethylvinyl ether-alt-maleic acid. The first and second basic materials may be selected independently from sodium hydroxide, potassium hydroxide, ammonium hydroxide, basic amines and mixtures thereof.

As illustrated in FIG. 7, in step 32, the cerium precursor compound is heated to the heat treatment temperature of between about 700° C. and about 900° C. under an oxidizing atmosphere form generally completely oxidized cerium oxide particles according to the exemplary method described above in connection with FIG. 5. As illustrated in FIG. 7, in step 34, the dispersion including the cerium oxide abrasive particles formed by dispersing the cerium oxide produced in step 32 in an aqueous solution according to the exemplary method described above in connection with FIG. 5.

As illustrated in FIG. 7, in step 36, a cerium oxide slurry is formed by mixing the dispersion including the cerium oxide abrasive particles with another aqueous solution or suitable additives in a ratio sufficient to form a suitable CMP slurry composition having a desired abrasive content, typically between about 1 and 10 wt % of the final CMP slurry composition. Accordingly, the relative volume ratios of the dispersion, the additive agents and any additional water will be adjusted to ensure that the abrasive and additives are present in the final CMP slurry composition at concentrations within the target ranges.

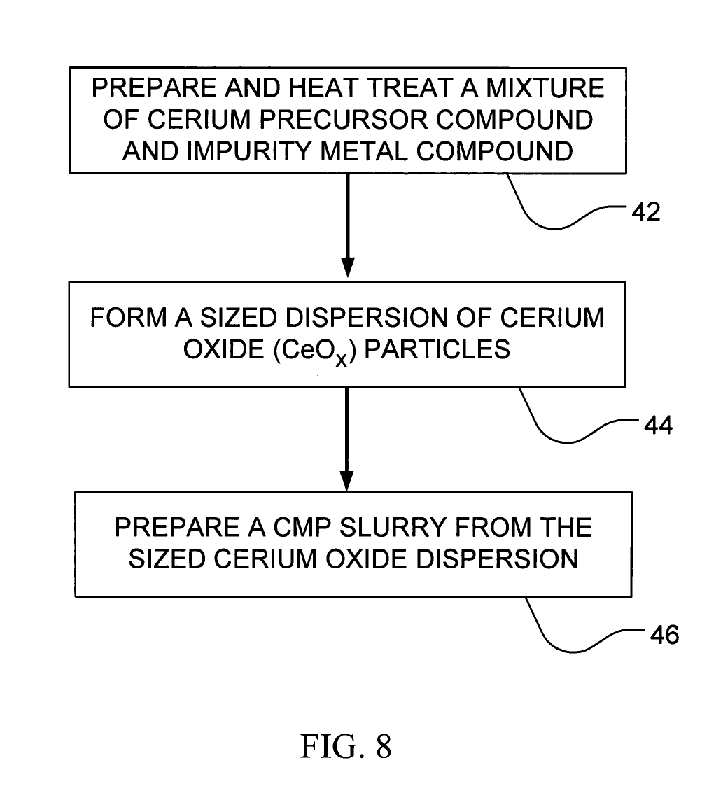

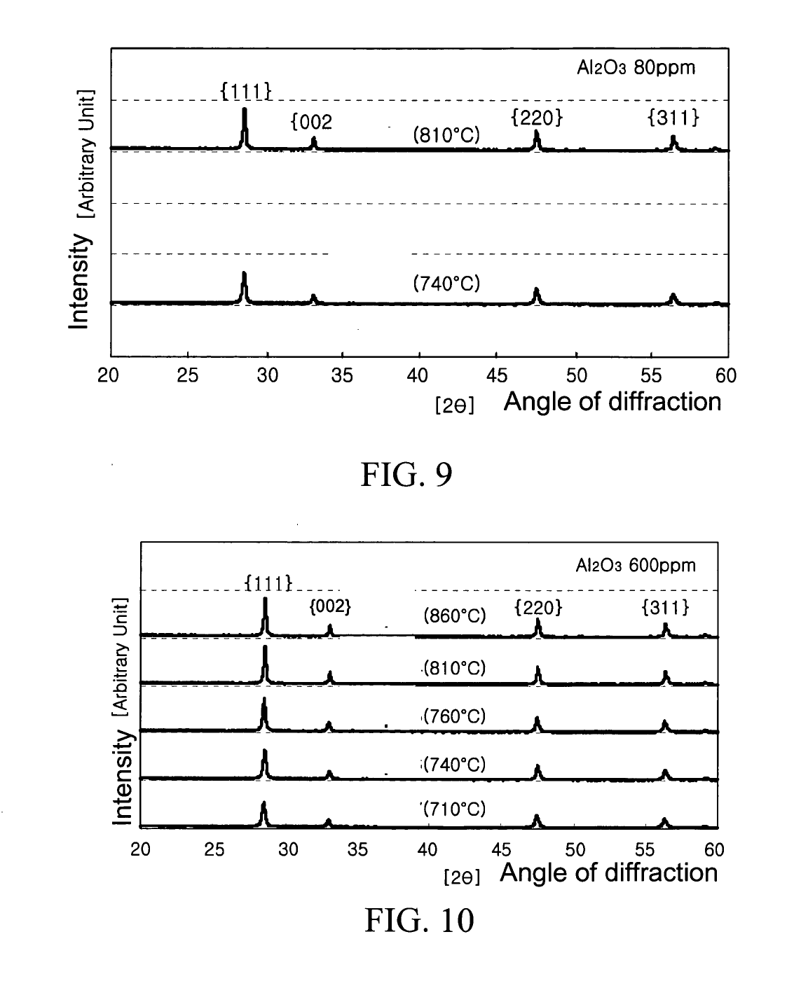

As illustrated in FIG. 8, in step 42, the cerium precursor compound is heated to the heat treatment temperature of between about 700° C. and about 900° C. under an oxidizing atmosphere conditions that prevent the complete oxidation of the cerium according to the exemplary method described above in connection with FIG. 6. As illustrated in FIG. 8, in step 44, the dispersion including the cerium oxide abrasive particles formed by dispersing the cerium oxide produced in step 42 in an aqueous solution according to the exemplary method described above in connection with FIG. 6.

As illustrated in FIG. 8, in step 46, a cerium oxide slurry is formed by mixing the dispersion including the cerium oxide abrasive particles with another aqueous solution or suitable additives in a ratio sufficient to form a suitable CMP slurry composition having a desired abrasive content, typically between about 1 and 10 wt % of the final CMP slurry composition. Accordingly, the relative volume ratios of the dispersion, the additive agents and any additional water will be adjusted to provide that the abrasive and additives are present in the final CMP slurry composition at concentrations within the target ranges.

### FIRST EXAMPLE

As reflected below in TABLE 1, cerium oxide polishing particles according to the invention were formed by heating a mixture of a cerium precursor compound and a trace metal oxide impurity in air. The resulting cerium oxide polishing particles were then analyzed to determine the average size of the primary crystallization particles and the residual concentration of the impurity metal.

A mixture of a cerium precursor compound, in this instance Ce₂(CO₃)₃, and a trace amount of a metal oxide impurity, Al₂O₃ at a concentration of 80 ppm (samples 1-2) or 600 ppm (samples 3-7) (based on the total weight of the Ce₂(CO₃)₃), was prepared and mixed for 90 minutes in a zirconia ball mill to provide relatively uniform mixing of the Ce₂(CO₃)₃ and Al₂O₃. The samples were then subjected to a three-hour heat treatment process under air at atmospheric pressure at various temperatures within the range of about 700° C. to about 900° C. The resulting cerium oxide particles were then evaluated to determine the average size of the cerium oxide primary particles and to determine the concentration of aluminum, as an indirect measure of the quantity of Al₂O₃, that had been incorporated into the cerium during the heat treatment process. The results of this evaluation are presented below in TABLE 1.

TABLE 1

| | | Heat | | Avg Size | | Post |
|---|---|---|---|---|---|---|
| | Initial | Treat- | | CeO₂ | Avg Size | Treatment |
| | Al₂O₃ | ment | | (Primary) | Al₂O₃ | Al₂O₃ |
| Sample | (ppm) | (° C.) | FWHM | (nm) | (nm) | (ppm) |
| 1 | 80 | 810 | 0.2144 | 48.1 | ND | 49 |
| 2 | 80 | 740 | 0.2803 | 40.5 | ND | 51 |
| 3 | 600 | 860 | 0.1999 | 47.7 | ND | 309 |
| 4 | 600 | 810 | 0.2231 | 42.9 | ND | 369 |
| 5 | 600 | 760 | 0.2507 | 40.8 | ND | 320 |
| 6 | 600 | 740 | 0.2293 | 37.1 | ND | 307 |
| 7 | 600 | 710 | 0.3179 | 35.0 | ND | 311 |

ND = Not Detected

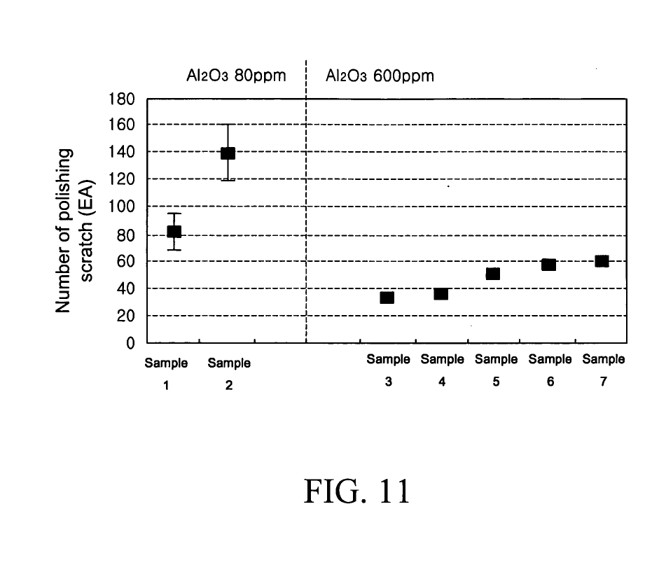

Reproduced in FIGS. 10 and 11 is the X-ray diffraction (XRD) data generated from polishing particles from each of the samples 1-7 listed in TABLE 1 with samples 1 and 2 shown in ascending order in FIG. 10 and samples 3-7 shown in ascending order in FIG. 11. The face directions or planes of the crystalline cerium oxide within the respective polishing particles (specifically the {111}, {002}, {220} and {3 11} crystalline planes) are reflected in corresponding peaks in the XRD data.

A FWHM (full width at half maximum) value was calculated from the diffraction results illustrated in FIGS. 10 and 11 and correlated to the average crystallization size within the polishing particle using a conventional method as detailed in Cullity, B. D., “Elements of X-ray diffraction,”, 3rd Ed. (2001) Prentice Hall, the contents of which are hereby incorporated, in its entirety, by reference.

As reflected in the XRD data of FIGS. 10 and 11 and the data presented in TABLE 1, as the heat treatment temperature ranged from 710° C. to 860° C., with the crystallization particle size (i.e., primary particles of FIG. 3A) ranging from 35 nm to 48.1 nm, the presence of an increased amount of the impurity metal appearing to suppress crystallization particle size somewhat. It is further noted that no peaks corresponding to Al₂O₃ crystallization particles were observed in the XRD data, indicating that even with an initial loading of 600 ppm, the Al₂O₃ is sufficiently distributed within the cerium oxide and/or along grain boundaries so as to be essentially undetectable via XRD, suggesting that the Al₂O₃ crystals, if present, are very small indeed, e.g., <5 nm.

Aqueous slurry compositions containing the polishing particles produced in samples 1-7 were then formed by combining the cerium oxide particles obtained after the heat treatment, D.I. water and a dispersion agent, in this instance polyacrylic acid-NH₄OH, and agitating the mixture at about 25° C. for about one hour, after which the mixtures were stirred at 1800 rpm for 100 minutes to form dispersions of the polishing particles in the aqueous solution. The dispersions were then separated in a centrifuge operating at 150 rpm for about 90 minutes.

Particles having a diameter of about 1 μm or greater were then removed and the remaining particles were filtered using a filter having a nominal pore size of 0.5 μm to obtain a dispersion predominately containing cerium oxide particles having a major dimension no greater than about 0.5 μm, which was then further diluted with D.I. water to obtain a dispersion in which the cerium oxide particles are present at about 5 wt %. The mean diameter size of the secondary particles in the final dispersions obtained from the samples 1-7 were, as reported below in TABLE 2, relatively small, ranging from about 86 nm to about 143 nm.

TABLE 2

| | | Mean Secondary |
|---|---|---|
| | Al₂O₃ Concentration | Particle Size |
| Sample | (Initial ppm) | (nm) |
| 1 | 80 | 119 |
| 2 | 80 | 86 |
| 3 | 600 | 143 |
| 4 | 600 | 125 |
| 5 | 600 | 109 |
| 6 | 600 | 103 |
| 7 | 600 | 86 |

A series of exemplary CMP slurries were then prepared by mixing the 5 wt % dispersions of the various cerium oxide abrasive particles with additional D.I. water and an additive agent solution at a volume ratio of 1:3:3 to form a slurry suitable for insulator CMP evaluation. Sample semiconductor wafers were prepared by forming a PE-TEOS layer to a thickness of about 12,000 Å and subjected to 90 second CMP processes using the sample CMP slurry compositions prepared with cerium oxide abrasives according to samples 1-7 above. The polished wafers were then cleaned using a conventional brush washing using HF diluted with D.I. water at a volume ratio of 200:1 and PVA (polyvinyl alcohol). The polished wafers were then dipped in a HF wet bath diluted with D.I. water at a volume ratio of 100:1 for 150 seconds, after which the sample wafers were dried using a spin drying process and evaluated for defects. The results of this evaluation are reflected in the graph provided as FIG. 11. As reflected in FIG. 11, increasing the quantity of the metal impurity added to the cerium precursor compound from 80 ppm to 600 ppm reduced the number of polishing defects observed on the sample wafers, even for cerium oxides subjected to higher heat treatment temperatures which would tend to increase the crystallinity of the resulting particles.

Although the invention has been described in connection with certain exemplary embodiments, it will be evident to those of ordinary skill in the art that many alternatives, modifications, and variations may be made to the disclosed methods in a manner consistent with the detailed description provided above. Also, it will be apparent to those of ordinary skill in the art that certain aspects of the various disclosed exemplary embodiments could be used in combination with aspects of any of the other disclosed embodiments or their alternatives to produce additional, but not herein illustrated, embodiments incorporating the claimed invention but more closely adapted for an intended use or performance requirements. Accordingly, it is intended that all such alternatives, modifications and variations that fall within the spirit of the invention are encompassed within the scope of the appended claims.

What is claimed is:

1. A method of preparing cerium oxide particles, comprising:
heating a mixture of a cerium precursor compound and a secondary metal compound to a heat treatment temperature of between about 700° C. and about 900° C. under an oxidizing ambient; and
maintaining the mixture at the heat treatment temperature for a treatment period sufficient to obtain a heat treated product in which substantially all of the cerium precursor compound has been converted to cerium oxide (CeOₓ), wherein the expression 0<x≦2 is satisfied, and further wherein the cerium oxide incorporates substantially all of the secondary metal compound as a secondary metal oxide.

2. A method of preparing cerium oxide particles according to claim 1, further comprising;
separating the cerium oxide according to particle size; and
forming an aqueous dispersion of cerium oxide particles within a predetermined particle size range.

3. A method of preparing cerium oxide particles according to claim 1, wherein:
the secondary metal compound is a metal oxide having a melting point at least 10° C. above the heat treatment temperature; and
the secondary metal compound is present in the mixture at a concentration whereby formation of separate secondary metal oxide particles during the heat treatment is suppressed.

4. A method of preparing cerium oxide particles according to claim 3, wherein:
the secondary metal compound includes at least one metal oxide selected from a group consisting of alumina (Al₂O₃), silica (SiO₂), titania (TiO₂), zirconia (ZrO₂) and manganesia (MnO₂).

5. A method of preparing cerium oxide particles according to claim 4, wherein:
the secondary metal compound is present in the mixture in a concentration of between about 300 ppm and about 1000 ppm.

6. A method of preparing cerium oxide particles according to claim 5, wherein:
the secondary metal compound is present in the mixture in a concentration of between about 500 ppm and about 1000 ppm.

7. A method of preparing cerium oxide particles according to claim 3, wherein:
secondary metal oxide particles present in the heat treated product have an average particle size of less than about 5 nm.

8. A method of preparing cerium oxide particles according to claim 3, wherein:
separate secondary metal oxide particles are undetectable in the heat treated product.

9. A method of preparing cerium oxide particles according to claim 2, wherein:
the cerium oxide particles include a plurality of primary cerium oxide particles, adjacent primary cerium oxide particles being separated by grain boundaries, wherein the secondary metal oxide is preferentially incorporated in the cerium oxide particles at the grain boundaries.

10. A method of preparing cerium oxide particles according to claim 1, wherein:
the cerium precursor compound has a melting point at least 10° C. greater than the heat treatment temperature.

11. A method of preparing cerium oxide particles according to claim 10, wherein:
the cerium precursor compound includes at least one compound selected from a group consisting of acetates, carbides, carbonates, chlorides, cyanates, bromides, fluorides, oxalates, sulfates, sulfites, and thiosulfates.

12. A method of preparing cerium oxide particles according to claim 11, wherein:
the cerium precursor compound includes at least one compound selected from a group consisting of Ce₂(CO₃)₃, Ce(OH)₄, CeC₂, Ce(O₂C₂H₃)₃, CeBr₃, CeCl₃, CeF₃, CeF₄, Ce₂(C₂₀ ₄)₃, Ce(SO₄)₂, and Ce₂(SO₄)₃, including both hydrated and anhydrous forms.

13. A method of preparing cerium oxide particles according to claim 12, further comprising:
dehydrating the cerium precursor compound before heating to the heat treatment temperature; and
combining the cerium precursor compound and the secondary metal compound to form the mixture, the mixture being substantially homogeneous, before initiating the heat treatment.

14. A method of preparing cerium oxide particles according to claim 12, wherein:
the cerium precursor compound is cerium carbonate (Ce₂(CO₃)₃), cerium hydroxide (Ce(OH)₄) or a mixture thereof.

15. A method of preparing cerium oxide particles according to claim 2, wherein:
separating the cerium oxide according to particle size utilizes at least one method selected from centrifugation, sedimentation and filtration.

16. A method of preparing cerium oxide particles according to claim 15, wherein:
separating the cerium oxide according to particle size further involves mechanically disrupting the cerium oxide before utilizing a separation method.

17. A method of preparing cerium oxide particles according to claim 16, wherein:
mechanically disrupting the cerium oxide includes at least one method selected from a group consisting of high-shear mixing, ball milling, grinding, Ultimizing®, microfluidizing, and pulverizing.

18. A method of preparing cerium oxide particles according to claim 15, wherein:
the predetermined particle size range is between about 50 nm and about 1000 nm.

19. A method of preparing cerium oxide particles according to claim 18, wherein:
the predetermined particle size range has a 3σ distribution of no more than about 30 percent of the average particle size.

20. A method of preparing cerium oxide particles according to claim 1, wherein:
the oxidizing ambient includes at least 20 volume percent oxygen and is at a pressure of at least about 1 atmosphere.

21. A method of preparing cerium oxide particles according to claim 1, wherein:
the secondary metal compound is incorporated in the mixture as separate particles or as a surface coating on cerium precursor compound particles.

22. A method of preparing cerium oxide particles according to claim 1, wherein:
the secondary metal compound is oxidized during the heat treatment to form the secondary metal oxide.

23. A method of preparing cerium oxide particles according to claim 1, wherein:
the secondary metal compound is an organometallic compound.

24. A method of preparing cerium oxide particles according to claim 1, wherein:
at the heat treatment temperature the secondary metal compound is a gas or a liquid.

25. A method of preparing a CMP slurry including cerium oxide particles comprising:
heating a mixture of a cerium precursor compound and a secondary metal compound to a heat treatment temperature of between about 700° C. and about 900° C. under an oxidizing ambient;
maintaining the mixture at the heat treatment temperature for a treatment period sufficient to obtain a heat treated product in which substantially all of the cerium precursor compound has been converted to cerium oxide (CeOₓ), wherein the expression 0<x≦2 is satisfied and wherein the cerium oxide incorporates substantially all of the secondary metal compound as a secondary metal oxide;
separating the cerium oxide according to particle size;
forming an aqueous dispersion of cerium oxide particles within a predetermined particle size range; and
combining the aqueous dispersion of cerium oxide particles with an aqueous additive solution in a predetermined proportion.

26. A method of preparing a CMP slurry including cerium oxide particles according to claim 25, wherein:
the secondary metal oxide is present in the cerium oxide particles in an amount sufficient to produce an effective secondary metal concentration of at least 50 ppm.

27. A method of preparing a CMP slurry including cerium oxide particles according to claim 25, wherein:
the aqueous dispersion includes at least one dispersing agent selected from a group consisting of anionic dispersants, cationic dispersants and non-ionic dispersants.

28. A method of preparing a CMP slurry including cerium oxide particles according to claim 25, wherein:
the additive solution includes at least one polymeric acid or a salt thereof and a base.

29. A method of preparing CMP slurry including cerium oxide according to claim 28, wherein:
the polymeric acid is selected from a group consisting of polyacrylic acid, polyacrylic-maleic acid and polymethyl vinyl ether-alt maleic acid; and
the base is selected from a group consisting of sodium hydroxide, potassium hydroxide, ammonium hydroxide and basic amines.

30. A method of preparing CMP slurry including cerium oxide according to claim 29, wherein:
the base is present in an amount sufficient to produce a slurry pH sufficient for an intended application of the slurry.

31. A method of preparing CMP slurry including cerium oxide according to claim 30, wherein:
the intended application is the removal of tungsten, copper, aluminum or an alloy thereof from a substrate; and
the base is present in an amount sufficient to produce an acidic slurry pH.

32. A method of preparing CMP slurry including cerium oxide according to claim 30, wherein:
the intended application is the removal of polysilicon or amorphous silicon from a substrate; and
the base is present in an amount sufficient to produce a basic slurry pH.

33. A method of preparing CMP slurry including cerium oxide according to claim 30, wherein:
the base is present in an amount sufficient to produce a slurry pH of between about 6 and about 8.

34. A method of preparing a CMP slurry including cerium oxide particles according to claim 25, wherein:
the additive solution includes
a first polymeric acid or a salt thereof and a first base; and
a second polymeric acid or a salt thereof and a second base.

35. A method of preparing a CMP slurry including cerium oxide particles according to claim 34, wherein:
the polymeric acids have different mean molecular weights and are independently selected from a group consisting of polyacrylic acid, polyacrylic-maleic acid and polymethyl vinyl ether-alt maleic acid; and
the first and second bases are independently selected from a group consisting of sodium hydroxide, potassium hydroxide, ammonium hydroxide and basic amines.

36. A method of preparing CMP slurry including cerium oxide according to claim 29, wherein:
the first and second bases are present in an amount sufficient to produce a slurry pH sufficient for an intended application of the slurry.

37. A method of preparing CMP slurry including cerium oxide according to claim 36, wherein:
the first and second bases are present in an amount sufficient to produce a slurry pH of between about 6 and about 8.

38. A method of preparing CMP slurry including cerium oxide according to claim 36, wherein:
the additive solution further includes at least one buffering agent.

39. A method of planarizing a substrate comprising:
placing the substrate on a carrier;
urging a primary surface of the substrate against a pad surface while generating relative motion between the substrate and the pad; and
applying a slurry composition to the pad so that a portion of the slurry composition is between the primary surface and the pad surface, the slurry composition cooperating with the pad surface to remove an upper portion of the substrate;
wherein the slurry composition includes cerium oxide particles, the cerium oxide particles comprising a plurality of primary cerium oxide (CeOₓ) particles, the expression 0<x≦2 being satisfied, and further wherein the cerium oxide particles incorporate a secondary metal oxide at grain boundaries formed between adjacent primary cerium oxide particles.

39. A method of planarizing a substrate according to claim 38, wherein:
the expression 1<x≦1.9 is satisfied; and
the secondary metal oxide is present in the cerium oxide particles at a concentration between about 300 ppm and about 1000 ppm.

40. A secondary cerium oxide particle, comprising:
a plurality of primary cerium oxide particles, adjacent primary cerium oxide particles being separated by grain boundaries, wherein a secondary metal oxide is incorporated in the secondary cerium oxide particles, the secondary metal oxide being preferentially segregated at the grain boundaries.

41. A secondary cerium oxide particle according to claim 40, wherein:
the secondary metal oxide is present within the secondary cerium oxide particle at a concentration between about 300 ppm and about 1000 ppm based on the cerium oxide.

42. A secondary cerium oxide particle according to claim 40, wherein:
the secondary metal oxide is present within the secondary cerium oxide particle as crystals having a major dimension sufficiently small so as to render the secondary metal oxide substantially undetectable by X-ray defraction.
